(19) United States
(12) Patent Application Publication
(10) Pub. No.: US 2020/0230774 A1
(43) Pub. Date: Jul. 23, 2020

(54) CHAMFERING DEVICE AND CHAMFERING METHOD

(71) Applicant: PLEX CO.,LTD., Hwaseong-si, Gyeonggi-do (KR)

(72) Inventors: Suk Hee LEE, Yongin-si (KR); Hyeong Geun YOO, Suwon-si (KR); Yang Ho HWANG, Pyeongtaek-si (KR); Tae Woo KIM, Hwaseong-si (KR); Young Pil KIM, Pyeongtaek-si (KR)

(73) Assignee: PLEX CO.,LTD., Hwaseong-si, Gyeonggi-do (KR)

(21) Appl. No.: 16/483,180

(22) PCT Filed: Jan. 16, 2018
(86) PCT No.: PCT/KR2018/000736

§ 371 Date: Aug. 2, 2019

(30) Foreign Application Priority Data
Feb. 2, 2017 (KR) 10-2017-0014900

(51) Int. Cl. B24B 9/10; C03B 29/02; C03B 37/012

(52) U.S. Cl. CPC B24B 9/10; C03B 37/01228; C03B 29/025

(57) ABSTRACT

The present invention relates to a chamfering device and a chamfering method and, more particularly, to a device for chamfering an edge of a glass substrate, comprising: a heating element which contacts a corner of the edge of the glass substrate and makes heat penetrate the edge of the glass substrate; and a moving unit for sliding the heating element along the edge of the glass substrate, wherein the moving unit slides the heating element so that the corner of the edge of the glass substrate is naturally peeled along the moving direction of the heating element so as to continuously generate chips to chamfer the glass substrate.

### TECHNICAL FIELD

The present invention relates to a chamfering device and a chamfering method.

### BACKGROUND ART

In general, flat display panels including a sensor glass use thin sheet glass, and in order to be used for flat display panels, the thin sheet glass is cut in a desired shape. During the cutting process, the thin sheet glass goes through a polishing operation for removing the fine cracks which inevitably occur at the corner of the thin sheet glass.

However, since static electricity and microscopic dust such as glass dust, etc. are produced during the process of polishing the corner of the thin sheet glass, supplementary equipment for blocking the microscopic dust should be installed. Also, due to the short circuit resulting from the static electricity, the image quality becomes poor and foreign substances are stuck to the thin sheet glass, and thus a large-scaled post-process of washing and drying should follow.

In order to overcome these disadvantages, a technique of sliding a heating element along the corner of the thin sheet glass so that the corner of the thin sheet glass is naturally peeled off together with the chip and the corner of the thin sheet glass is chamfered is disclosed.

However, due to the feature of glass which is an amorphous solid, the heat conduction is not uniform, and accordingly the chamfered amount is not uniform. Also, disconnection occurs during the process of generating chips, and the chamfered surface of the disconnected part is caved in, causing defects. Due to these problems, glass has not been commercialized yet.

### Technical Problem

The present invention was created in order to improve the problems of prior art, and thus it is an object of the present invention to provide a chamfering device and a chamfering method which allow uniform heat conduction along a corner of a glass substrate so as to accomplish natural chamfering by peeling the corner of the glass substrate.

It is another object of the present invention to provide a chamfering device and a chamfering method which allow the chip not to be disconnected during the process for peeling the corner of the glass substrate, thereby preventing a poor chamfering yield.

It is yet another object of the present invention to provide a chamfering device and a chamfering method which allow a heating element sliding along the edge of the glass substrate not to be adhered to the chip which is peeled from the corner of the edge of the glass substrate.

### Technical Solution

The chamfering device according to one embodiment of the present invention is a device for chamfering an edge of a glass substrate, comprising: a heating element which contacts a corner of the edge of the glass substrate and makes heat penetrate the edge of the glass substrate; and a moving unit for sliding the heating element along the edge of the glass substrate, wherein the moving unit slides the heating element so that the corner of the edge of the glass substrate is naturally peeled along the moving direction of the heating element so as to continuously generate chips to chamfer the glass substrate.

Specifically, the heating element may include at least platinum.

Specifically, the heating element may be a mixture of at least rhodium and platinum.

Specifically, the heating element may be a mixture of rhodium and platinum so that the ratio of platinum is relatively higher than rhodium.

Specifically, a housing formed with a working space which accommodates the glass substrate therein, chamfers the edge of the glass substrate, and is isolated from the outside may be further included.

Specifically, the housing may include a temperature adjustment which adjusts the temperature of the working space or a pressure adjustment unit which adjusts the pressure of the working space.

Specifically, the housing may maintain a constant temperature or pressure of the working space.

Specifically, the pressure adjustment unit may adjust the pressure of the working space to correspond to the thermal expansion coefficient of the glass substrate.

Specifically, the pressure adjustment unit may adjust the pressure of the working space to a pressure higher than a reference pressure when the thermal expansion coefficient of the glass substrate is high, and may adjust the pressure of the working space to a pressure lower than the reference pressure when the thermal expansion coefficient of the glass substrate is low.

Specifically, the housing further includes a sensor which senses at least one of the temperature and the pressure of the working space.

Specifically, the pressure adjustment unit may adjust the pressure of the working space by injecting inert gas into the working space, or discharging gas inside the working space to the outside.

Specifically, a preheating unit which preheats the edge of the glass substrate before being brought into contact with the heating element may be further included.

Specifically, the preheating unit may preheat the edge of the glass substrate to a temperature above the temperature inside the working space and below the heating temperature of the heating element.

Specifically, the preheating unit may further include a cooling unit which cools the glass substrate before or after heating the edge of the glass substrate.

Specifically, the cooling unit may cool the glass substrate by contacting the glass substrate, lowering the temperature inside the working space, or spraying a refrigerant to the glass substrate.

Specifically, the temperature adjustment unit may maintain the temperature inside the working space to range between 0 and 10° C., and the cooling unit may cool the glass substrate to range between −10 and 0° C.

Specifically, the cooling unit cools the glass substrate by contacting the glass substrate before the preheating unit preheats the edge of the glass substrate, and cools the edge of the glass substrate by spraying a refrigerant to the edge of the glass substrate after preheating the edge of the glass substrate.

The chamfering method according to one embodiment of the present invention is a method for chamfering an edge of a glass substrate, comprising the steps of: contacting a heating element with a corner of the edge of the glass substrate and making heat penetrate the edge of the glass substrate; sliding the heating element along the edge of the glass substrate so that the corner of the edge of the glass substrate is naturally peeled along the moving direction of the heating element so as to continuously generate chips; and interlocking with the generation of chips to chamfer the glass substrate.

Specifically, the heating element may include at least platinum.

Specifically, the heating element may be a mixture of at least rhodium and platinum.

Specifically, the steps of making heat penetrate the edge of the glass substrate, forming the chip, and chamfering the glass substrate may be carried out in a working space which accommodates the glass substrate therein, chamfers the edge of the glass substrate, and is isolated from the outside.

Specifically, the step of adjusting the pressure of the working space to correspond to the thermal expansion coefficient of the glass substrate may be further included.

Specifically, the step of adjusting the pressure of the working space may adjust the pressure of the working space to a pressure higher than a reference pressure when the thermal expansion coefficient of the glass substrate is high, and may adjust the pressure of the working space to a pressure lower than the reference pressure when the thermal expansion coefficient of the glass substrate is low.

Specifically, the step of preheating xe edge of the glass substrate before being brought into contact with the heating element may be further included.

Specifically, the step of cooling the glass substrate by contacting the cooling unit with the glass substrate before preheating the edge of the glass substrate may be further included.

Specifically, in the step of preheating the edge of the glass substrate, the cooling unit may stay in contact with the glass substrate to maintain a constant depth of the heat conducted at the edge of the glass substrate by the preheating unit.

Specifically, the step of cooling the edge of the glass substrate by spraying a refrigerant to the edge of the glass substrate after preheating the edge of the glass substrate may be further included.

Specifically, the step of cutting the thin sheet glass to generate the glass substrate may be further included.

The chamfering device and the chamfering method according to the present invention perform uniform heat conduction along the corner of the glass substrate so as to accomplish a naturally smooth chamfering by peeling the corner of the glass substrate.

Additionally, the chamfering device and the chamfering method according to the present invention perform uniform heat conduction along the corner of the glass substrate so as to prevent the chips from being disconnected during the process for peeling the corner of the edge of the glass substrate.

Also, the chamfering device and the chamfering method according to the present invention allow the heating element sliding along the edge of the glass substrate not to be adhered to the chip which is peeled from the corner of the edge of the glass substrate, thereby improving durability of the heating element.

### BRIEF DESCRIPTION OF FIGURES

FIG. 1 is a perspective view illustrating the chamfering device according to one embodiment of the present invention;

FIG. 2 is a rear view illustrating the chamfering device according to one embodiment of the present invention;

FIG. 3 is a perspective view illustrating the chamfering device according to one embodiment of the present invention with the housing removed;

FIG. 4 is a plan view illustrating the chamfering device according to one embodiment of the present invention with the housing removed;

FIG. 5 is a partially enlarged perspective view illustrating the chamfering device according to one embodiment of the present invention with the housing removed;

FIG. 6 is a partially enlarged perspective view illustrating the chamfering device according to one embodiment of the present invention with the housing removed;

FIG. 7 is a conceptual view illustrating the chamfering device according to one embodiment of the present invention;

FIG. 8 is a partially enlarged view illustrating a chamfering process of the chamfering device according to one embodiment of the present invention;

FIG. 9 is a partially enlarged view illustrating a chamfering process of the chamfering device according to one embodiment of the present invention;

FIG. 10 is a partially enlarged view illustrating a chamfering process of the chamfering device according to one embodiment of the present invention;

FIG. 11 is a partially enlarged view illustrating a chamfering process of the chamfering device according to one embodiment of the present invention;

FIG. 12 is a view illustrating a heating element of the chamfering device according to one embodiment of the present invention;

FIG. 13 is a partial perspective view illustrating a chamfering process of the chamfering device according to one embodiment of the present invention; and

FIG. 14 is a flow chart of the chamfering method according to one embodiment of the present invention.

### EXAMPLES

The objects, specified advantages and novel features of the present invention may be further clarified by the detailed description and preferable embodiments when considered in connection with the accompanying drawings. When adding reference numerals to constitutional elements in each drawing of the present specification, it should be noted that the same constitutional elements should have the same number, if possible, even if they are used in different drawings. Additionally, when explaining the present invention, when it is determined that the detailed description on a relevant published technique may obscure the gist of the present invention, the detailed description thereof is omitted.

Hereinafter, preferable embodiments of the present invention are explained in detail with reference to the accompanying drawings.

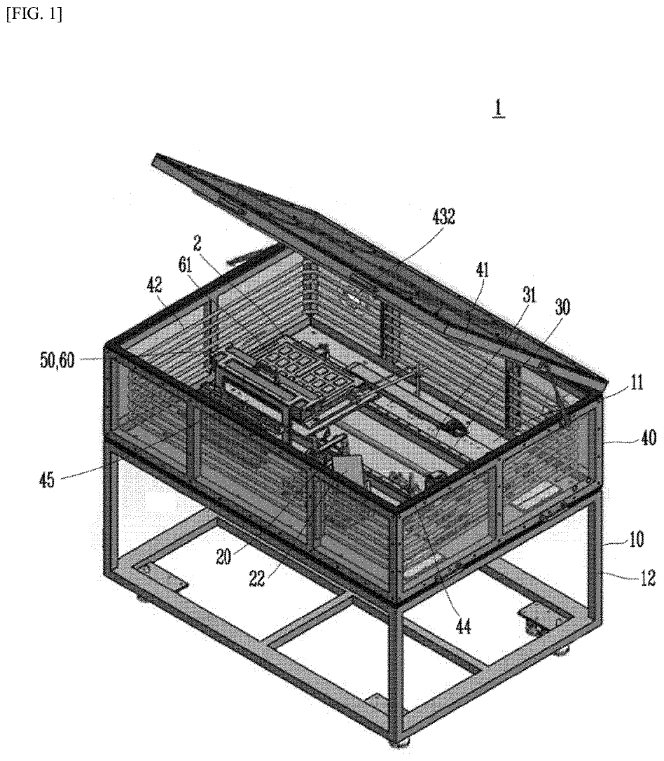

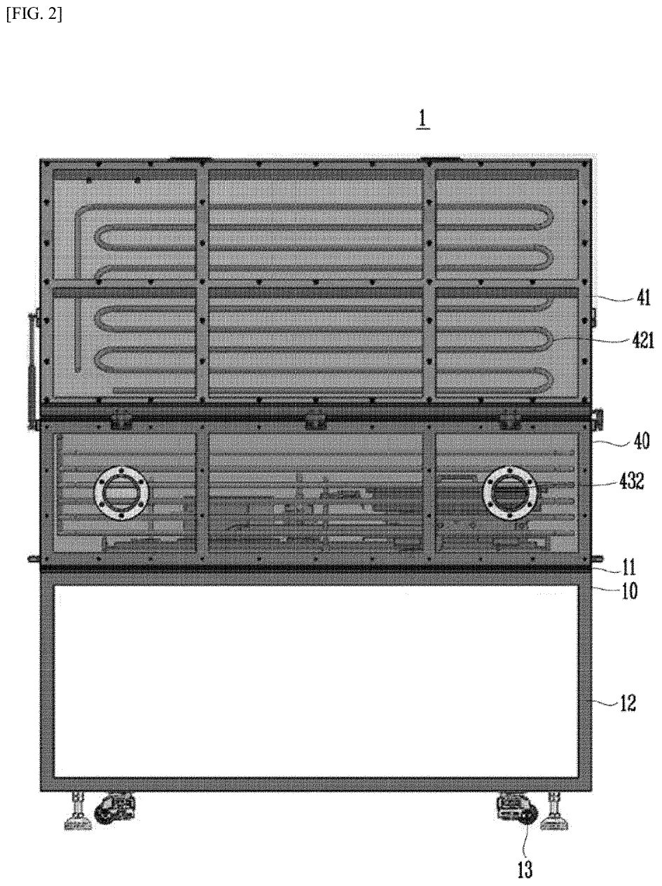

FIG. 1 is a perspective view illustrating the chamfering device according to one embodiment of the present invention, and FIG. 2 is a rear view illustrating the chamfering device according to one embodiment of the present invention.

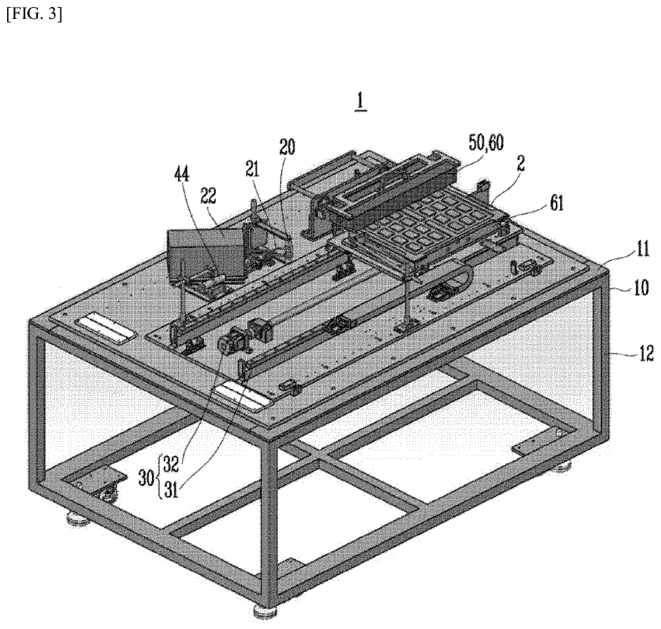

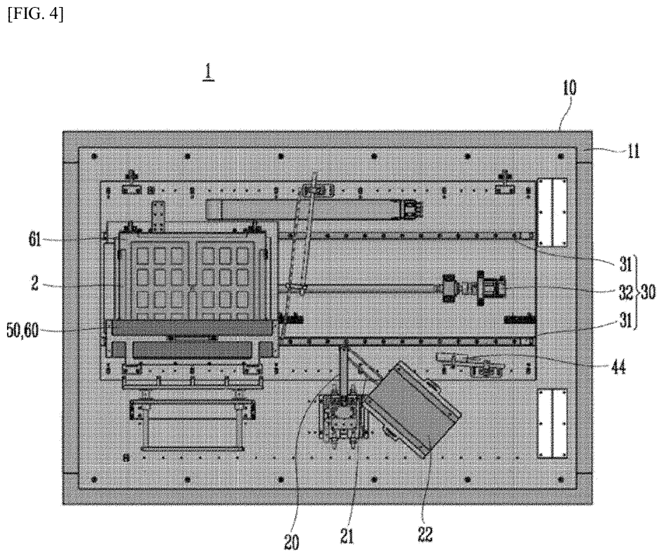

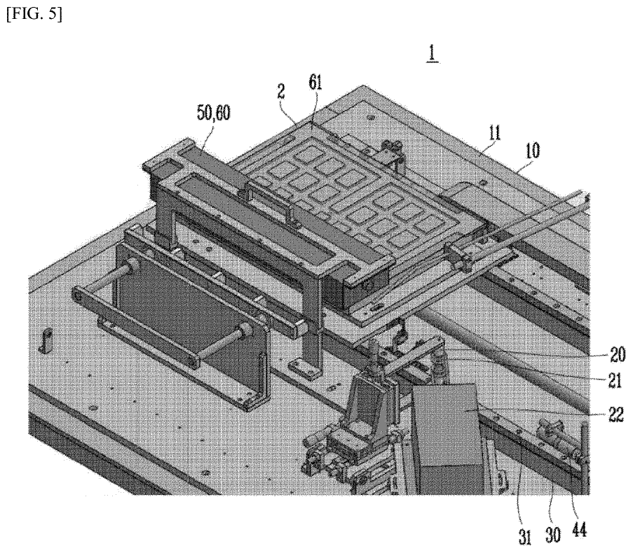

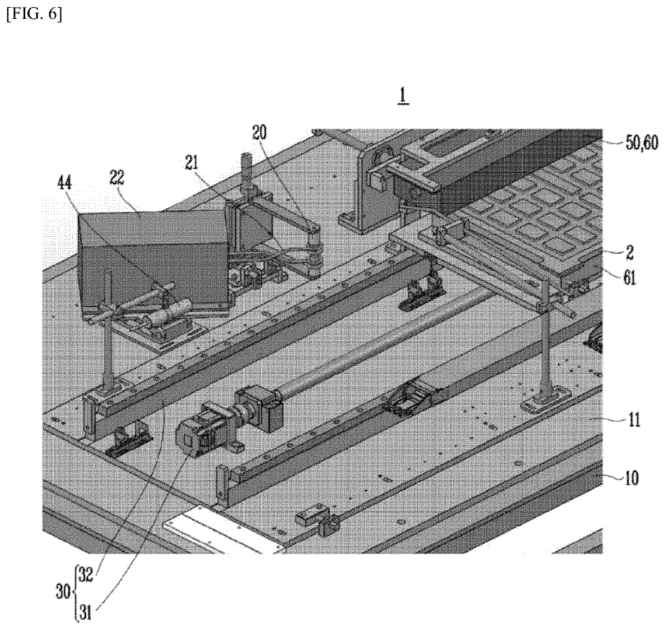

FIG. 3 is a perspective view illustrating the chamfering device according to one embodiment of the present invention with the housing removed, FIG. 4 is a plan view illustrating the chamfering device according to one embodiment of the present invention with the housing removed, FIG. 5 is a partially enlarged perspective view illustrating the chamfering device according to one embodiment of the present invention with the housing removed, and FIG. 6 is a partially enlarged perspective view illustrating the chamfering device according to one embodiment of the present invention with the housing removed.

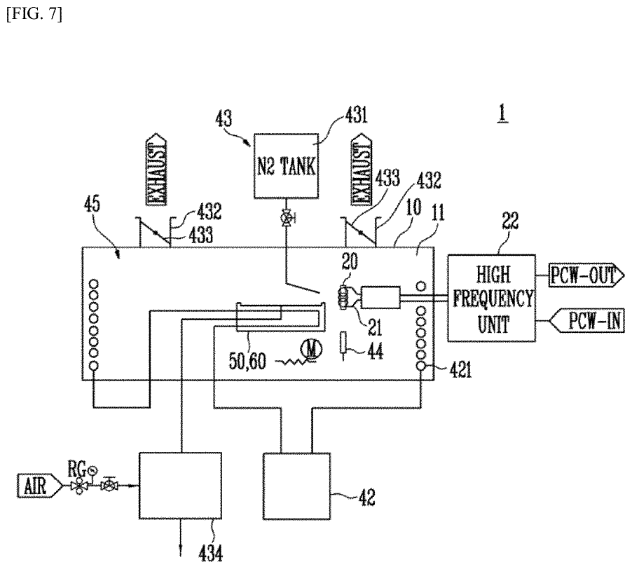

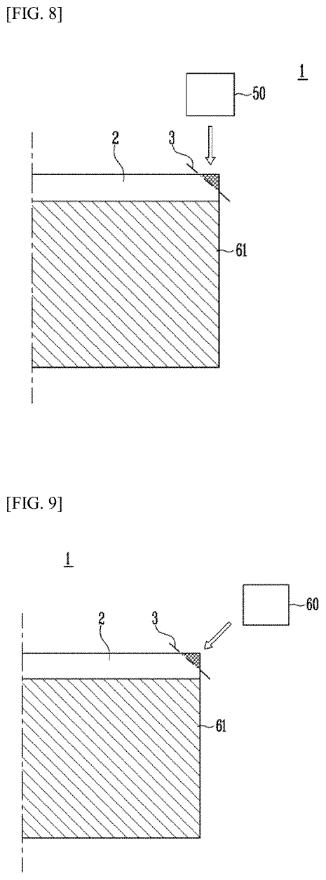

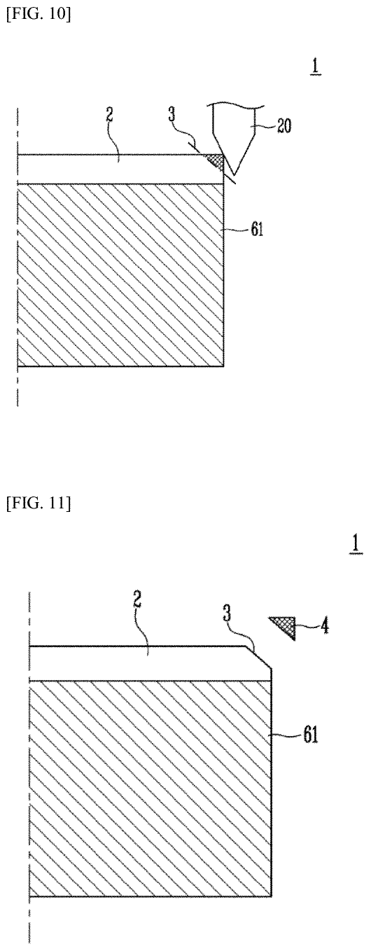

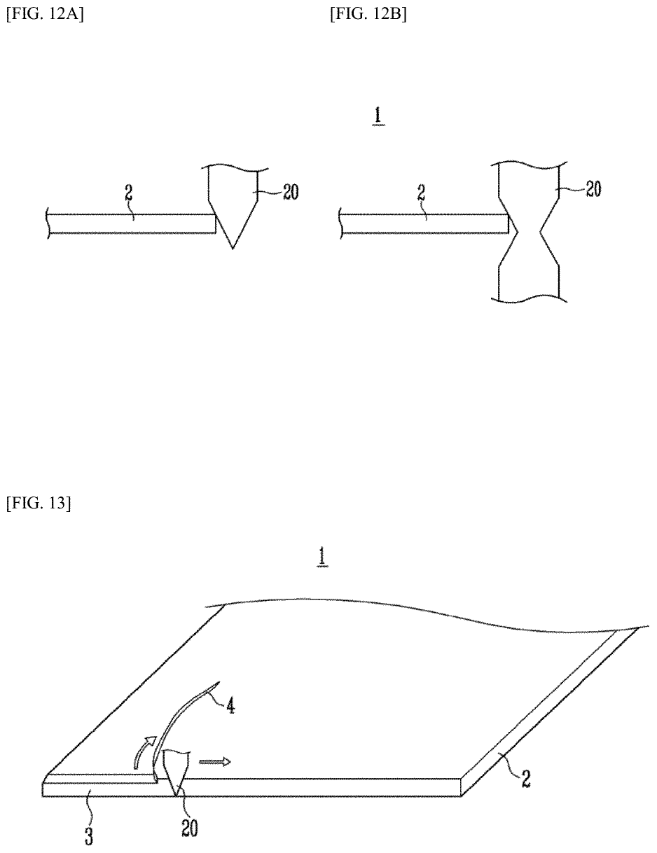

FIG. 7 is a conceptual view illustrating the chamfering device according to one embodiment of the present invention, FIGS. 8 to 11 are is partially enlarged views illustrating a chamfering process of the chamfering device according to one embodiment of the present invention, FIG. 12 is a view illustrating a heating element of the chamfering device according to one embodiment of the present invention, and FIG. 13 is a partial perspective view illustrating a chamfering process of the chamfering device according to one embodiment of the present invention.

When referring to FIGS. 1 to 13, the chamfering device 1 according to one embodiment of the present invention is a device which chamfers an edge of a glass substrate 2, and includes a frame 10, a heating element 20, a moving unit 30, a housing 40, a preheating unit 50, and a cooling unit 60.

In this case, the glass substrate 2 may be generated by cutting thin sheet glass, and the chamfering device 1 may further include a cutting unit (not illustrated) which generates the glass substrate 2 by cutting thin sheet glass. The cutting unit may be a grinder or a laser, etc., but any cutting unit would be sufficient as far as it cuts thin sheet glass, and the cutting manner or structure, etc. is not particularly limited.

The glass substrate 2 cut by a cutting unit may have small scratches at the edge thereof. In this case, stress may be centered on the scratches, and thus it is likely that the glass substrate 2 may break. In this regard, the present invention can remove scratches by chamfering the edge as will be explained later.

According to the present invention, the chamfering device 1 may be a concept which includes all processes that could be added before or after the chamfering process such as cutting, transferring, washing, wrapping, etc. in addition to the process of chamfering the corner of the edge of the glass substrate 2. Therefore, the chamfering device 1 of the present invention may be interpreted as a device for processing the glass substrate 2.

As the glass substrate chamfered in the present invention has an amorphous structure, the amount of heat conducted inside the glass substrate 2 is irregular, and thus it would be difficult to provide continuous chamfering. However, as will be explained later, the present invention allows uniform heat conduction during processes such as preheating, etc., and thus the above-mentioned problem may be overcome, and continuous and neat chamfering may be accomplished.

In this case, the glass substrate 2 may a glass substrate used in a display device, etc., but the usage of the glass substrate 2 is not particularly limited. Additionally, the glass substrate 2 may be interpreted as an expression including all products which have a substrate form and accompany a cutting process, such as silicon wafer, etc., in addition to glass.

The frame 10 forms a shelf 11 in which the glass substrate 2 may be chamfered. The frame 10 may have a skeleton form, and may have a support 12 so as to be supported on a location fixed from the ground. Of course, the frame 10 may include a caster 13 in order to change the location of the shelf 11.

Meanwhile, during the chamfering process, the caster 13 may be remoted from the ground, and the support 12 may close in to the ground. Only when the chamfering device 1 needs to be transferred, the caster 13 descends to allow the support 12 to be remoted from the ground, so that the location of the chamfering device is easily changed.

The frame 10 may be made of metal, etc., but the material of the frame 10 is not particularly limited in the present invention. Additionally, the structure of the frame 10 is not particularly limited as far as a shelf 11 for chamfering a glass substrate 2 can be formed.

As illustrated in FIG. 10, the heating element 20 contacts the corner of the edge of the glass substrate 2, and makes heat penetrate the edge of the glass substrate 2. The heating element 20 may be formed in a pole shape made of metal having heat conductivity. The heating element may include at least platinum (Pt), and specifically, may be an alloy of a mixture of rhodium (Rh) and platinum (Pt).

In this case, the heating element 20 may be a mixture of rhodium and platinum so that the ratio of platinum is higher than rhodium. As one example, the heating element 20 may be a mixture of 10 to 40% (for example, around 20%) of rhodium and 60 to 90% of platinum (for example, around 80%).

Conventionally, molybdenum disilicide which is obtained by mixing molybdenum and glass dust and sintering the same was used for heating. However, in case of performing chamfering by using a heating element 20 including molybdenum disilicide, when the heating element 20 slides, some of the glass residue melted from the corner of the glass substrate 2 adhered to the heating element 20.

Accordingly, in the past, due to the glass residue adhered to the heating element 20, glass was thickly coated on the heating element 20, and accordingly, there was a problem in conducting heat as a heating element 20, and it became impossible to perform chamfering.

However, since the heating element 20 of the present invention includes platinum, the adhesion of the glass residue to the heating element 20 during the process of sliding along the glass substrate 2 may be minimized. Therefore, the heating element 20 of the present invention is very suitable for the continuous and accurate chamfering work for the edge of the glass substrate 2.

The heating element 20 may include a coil 21, and heating may be implemented by a coil 21 using high frequency. Of course, the heating source of the heating of the heating element 20 is not particularly limited, and the healing temperature of the heating element 20 may be about 1,000 to 2,000° C. (preferable, between 1,200 and 1,600° C.)

In order for the heating element 20 to be heated, a power unit 22 may be connected to the heating element 20. The power unit 22 may receive electricity from the outside and deliver the same to the coil 21 so that heat could be emitted through the coil 21.

The heating element 20 may have a form incline meeting the corner of the edge of the glass substrate 2. The heating element 20 may be in a shape getting sharper towards the front end as illustrated in FIG. 12(A), or may be in the shape of a sandglass, etc. whose middle portion is concavely recessed as illustrated in FIG. 12(B).

In the former case, the heating element 20 may be used for chamfering an upper corner of the edge of the glass substrate 2, and in the latter case, the heating element 20 may be used for chamfering an upper corner and a lower corner of the edge of the glass substrate 2. Of course, even in the former case, it is possible to chamfer both the upper corner and lower corner of the edge of the glass substrate 2 by turning over the glass substrate 2 after the first chamfering and then performing second chamfering.

An inclination angle where the heating element 20 meets the glass substrate 2 may form an angle chamfered to the glass substrate 2. The heating element 20 may not only move but also rotate by the moving unit 30 which will be mentioned later, and thus the heating element 20 may be provided so that the chamfering angle could be adjusted.

The moving unit 30 slides the heating element 20 along the edge of the glass substrate 2. The moving unit 30 may move the heating element 20, and/or move the glass substrate 2. In other words, the moving unit 30 allows the heating element 20 to carry out a relative movement with respect to the edge of the glass substrate 2, so that the heating element 20 could slide along the edge of the glass substrate 2.

In this case, it would be sufficient for the moving unit 30 to slide the heating element 20 by using structures such as LM guides, chains, gantries, etc., and the detailed structure, etc. of the moving unit 30 is not particularly limited.

Meanwhile, for example, the moving unit 30 can move the glass substrate 2 while supporting the glass substrate 2 on two rails 31 so that the heating element 20 fixed on the shelf 11 could slide along the edge of the glass substrate 2.

In this case, the moving unit 30 has a motor 32 allowing the motor 32 to rotate by the sliding of the heating element 20, and the structure which converts a rotational force into a straight movement could be accomplished in various ways.

The moving unit 30 may vary the angle where the heating element 20 contacts the glass substrate 2 while implementing the sliding of the heating element 20. For example, the moving unit 30 may rotate the heating element 20 to adjust the chamfering angle of the glass substrate 2.

Additionally, the moving unit 30 may adjust the height of the heating element 20 with respect to the edge of the glass substrate 2. As explained above with reference to FIG. 12(B), the heating element 20 may be in the shape of a sandglass. The moving unit 30 allows the heating element 20 to meet the upper corner of the edge of the glass substrate 2, and then allows the heating element 20 to meet the lower corner of the edge of the glass substrate 2 by raising the heating element 20.

Of course, the height of the heating element 20 may be adjusted by lifting or lowering the heating element 20 up and down and/or lifting or lowering the glass substrate 2. Meanwhile, the angle of the heating element 20 may be adjusted by adjusting only the angle of the heating element 20, not the angle of the glass substrate 2.

When the moving unit 30 slides the heating element 20, heat penetrates into the corner of the edge of the glass substrate 2 from the heating element 20. In this case, the corner of the edge of the glass substrate 2 melts and thus is naturally peeled along the moving direction of the heating element 20.

When the corner of the edge of the glass substrate 2 is naturally peeled, chips 4 are continuously generated. In this case, the chips 4 may fall off the edge of the glass substrate 2 like apple peels.

In this case, when the chip 4 falls off, the corner of the edge of the glass substrate 2 corresponding to a portion where the chip 4 falls off may be naturally chamfered. Therefore, the present invention may implement chamfering by forming the chip 4 through melting, not polishing, and particularly the present invention enables continuous and uniform chamfering.

The housing 40 forms a working space 45 which accommodates the glass substrate 2 therein, chamfers the edge of the glass substrate 2, and is isolated from the outside. The housing 40 surrounds the upper side space of the shelf 11 of the frame 10 to form a working space 45 independent from the outside.

The housing 40 may have a hexahedron shape with the shelf 11 as a bottom surface, and at least one surface may be formed to allow opening and closing. For example, the top surface of the housing 40 may include an opening/closing unit 41, and the opening/closing may be accomplished by hinge rotation, sliding and/or simple dismounting, etc.

The housing 40 forms the working space 45 to be isolated from the outside, so that the environment for chamfering the glass substrate 2 can be optimally adjusted. For example, the housing 40 may implement adjustments such as maintaining a constant temperature and/or pressure inside the working space 45, and to this end, the housing 40 may include a temperature adjustment unit 42 which adjusts the temperature of the working space 45 and/or a pressure adjustment unit 43 which adjusts the pressure of the working space 45.

The temperature adjustment unit 42 may be in the shape of a coil, etc., and may be positioned on an inner wall in the housing 40. The temperature adjustment unit 42, for example, may include a chiller 421, etc. which emits cold heat, maintain the temperature inside the working space 45 to range between about 0 to 10° C.

Of course, the temperature adjustment unit 42 may implement the function of raising the temperature inside the housing 40. Meanwhile, the temperature adjustment unit 42 maintains the temperature inside the housing 40 to be lower than the outside temperature (room temperature and maintains uniform heat conduction in the glass substrate 2, thereby guaranteeing chamfering quality.

The pressure adjustment unit 43 may maintain a constant pressure inside the housing 40 during the process of chamfering the glass substrate 2. When the corner of the edge of the glass substrate 2 melts and is peeled off to form e chip 4, the pressure adjustment unit 43 maintains a constant level of peeling-off of the chip 4.

Particularly, the pressure adjustment unit 43 may adjust the pressure of the working space 45 to correspond to the thermal expansion coefficient of the glass substrate 2. Specifically, the pressure adjustment unit 43 may adjust the pressure of the working space 45 to a pressure higher than a reference pressure when the thermal expansion coefficient of the glass substrate 2 is high, and may adjust the pressure of the working space 45 to a pressure lower than the reference pressure when the thermal expansion coefficient of the glass substrate 2 is low.

In this case, the reference pressure may be the pressure outside of the working space 45, and may be an atmospheric pressure, for example. The thermal expansion coefficient may be input manually to the pressure adjustment unit 43 by a user, etc., and/or may be automatically sensed through a measurement unit (not illustrated), etc. connected to the pressure adjustment unit 43.

When the thermal expansion coefficient of the glass substrate 2 is high, the chip may be easily peeled off when the corner of the edge is melted by the heating element 20. Therefor-, the pressure adjustment unit 43 may adjust the pressure of the working space 45 to be a positive pressure so that the peeling of the chip 4 could be properly adjusted.

To the contrary, when the thermal expansion coefficient of the glass substrate 2 is low, even if the corner of the edge is melted, the chip 4 may not be properly peeled off. Therefore, the pressure adjustment unit 43 may adjust the pressure of the working space 45 to be a negative pressure so that the chip 4 could be properly peeled off.

As such, the present invention isolates the space where the glass substrate 2 is chamfered from the outside, and properly adjusts the pressure of the working space 45 according to the thermal expansion coefficient of the glass substrate 2, thereby maintaining a uniform peeling-off of the corner of the edge of the glass substrate 2. Accordingly, the present invention allows chips 4 to be continuously formed, thereby preventing the generation of scratches, or protrusions, etc. during the chamfering process.

The pressure adjustment unit 43 may adjust the pressure of the working space 45 by injecting inert gas into the working space 45, or discharging gas inside the working space 45. To this end, the pressure adjustment unit 43 may include a gas injection unit 431 which supplies inert gas to the working space 45, and may also include a discharge duct 432 which discharges the gas inside the working space 45 to the outside. Here, the discharge duct 432 may include a valve (not illustrated) or a damper 433 for adjusting the opening of the discharge duct 432.

Of course, how the pressure adjustment unit 43 adjusts the pressure inside the working space 45 is not limited to the above. Additionally, when discharging gas using the discharge duct 432, in case the pressure inside the working space 45 does not fall below the outside pressure, the pressure adjustment unit 43 may further include a negative pressure forming unit 434 which forcedly discharges the gas inside the working space 45. In order for the pressure adjustment unit 43 to maintain a constant pressure inside the working space 45 through these constitutions, the housing 44 may include a sensor 44 which measures the pressure, etc.

In this case, the sensor 44 may be provided in the working space 45, and in addition to pressure, the sensor 44 may measure temperature so that the temperature adjustment unit 42 could maintain a constant temperature inside the working space 45. Meanwhile, the sensor 44 may be spaced apart from the heating element 20, which is to prevent the heating of the heating element 20 from affecting the measurement values of temperature or pressure.

The preheating unit 50 preheats the edge of the glass substrate 2 before being brought into contact with the heating element 20. The preheating unit 50 may preheat the edge of the glass substrate 2 to a temperature above the temperature inside the working space 45 and below the heating temperature of the heating element 20.

As illustrated in FIG. 8, the preheating unit 50 may spray hot air onto the glass substrate 2, or supply radiant heat to the glass substrate 2, etc. Also, like the heating element 20, the preheating unit 50 may deliver heat along the edge of the glass substrate 2. Therefore, the edge of the glass substrate 2 may be heated to a temperature higher than the current temperature, and in this case, it would be possible to reduce the energy which should be delivered through the heating element 20 for chamfering the edge of the glass substrate 2, and thus it would be possible to save the power consumed by the power unit 22 of the heating element 20.

The preheating unit 50 may move at a constant velocity so that the edge of the glass substrate 2 could be uniformly heated, and may supply the same amount of heat per unit time to the edge of the glass substrate 2.

In this case, the heat delivered to the edge of the glass substrate 2 through the preheating unit 50 may be smoothly moved to the bottom. The preheating unit 50 may supply heat from the top of the edge of the glass substrate 2 to the bottom, and the heat delivered to the glass substrate 2 moves in a vertically downward orientation or an obliquely downward orientation by a cooling unit 60, which will be mentioned later.

As explained above, since the glass substrate 2 has an amorphous structure, the amount of heat conducted from the inside is irregular. If the heat delivered from the preheating unit 50 to the glass substrate 2 by the cooling unit 60 has an orientation, the heat may be uniformly conducted at the edge of the glass substrate 2. This will be explained in detail in the section explaining the cooling unit 60.

The cooling unit 60 may cool the glass substrate 2 before and/or after preheating the edge of the glass substrate 2. The cooling unit 60 may cool the glass substrate 2 by contacting the glass substrate 2, lowering the temperature inside the working space 45 or spraying a refrigerant to the glass substrate 2.

The cooling unit 60 may be omitted by the temperature adjustment unit 42 explained above. In other words, when the temperature adjustment unit 42 included in the housing 40 serves as the cooling unit 60 which cools the glass substrate 2 before and after preheating the glass substrate, the cooling unit 60 may be omitted.

Meanwhile, even when including a temperature adjustment unit 42, the cooling unit 60 may contact the glass substrate 2 before preheating the glass substrate 2, thereby implementing uniform heat conduction, and the temperature adjustment unit 42 may lower the temperature of the working space 45 before and after preheating the glass substrate 2 to cool the glass substrate 2. Additionally, the cooling unit 60 may share the refrigerant with the temperature adjustment unit 42.

The cooling unit 60 may include a cooling plate 61 which contacts the glass substrate 2 before preheating the edge of the glass substrate 2 to cool the glass substrate. The cooling plate 61 may support the glass substrate 2, and contact an opposite side of the chamfered portion in the glass substrate 2.

The cooling plate 61 is configured to maintain a temperature lower than room temperature, and may maintain a temperature lower than the temperature inside the working space 45 adjusted by the temperature adjustment unit 42. For example, the cooling plate 61 may maintain the temperature to range between −10 and 0° C. In other words, the difference between the temperature of the cooling plate 61 and the temperature inside the working space 45 may be maintained to range between about 10 and 20° C.

The glass substrate 2 may be mounted on the top surface of the cooling plate 61. Heat may be supplied to the top surface of the glass substrate 2 by a preheater while the bottom surface of the glass substrate 2 is cooled to range between −10 and 0° C. by the cooling plate 61.

In this case, the cooling plate 61 placed on the bottom of the glass substrate 2 may allow the heat applied from the heating unit 50 to the edge of the glass substrate 2 to move smoothly to the bottom.

In other words, when the preheating unit 50 preheats the edge of the glass substrate 2, since the cooling plate 61 maintains a low temperature condition and stays in contact with the glass substrate 2, the heat delivered to the edge of the glass substrate 2 by the preheating unit 50 may move in a vertically downward orientation or an obliquely downward orientation.

Therefore, the cooling plate 61 leads the conduction of heat in a constant orientation with respect to the conductive heat inside the glass substrate 2 so as to maintain a constant depth of the heat conducted at the edge of the glass substrate along the longitudinal direction of the glass substrate 2, thereby forming a uniform conductive heat along the longitudinal direction of a side portion of the glass substrate 2 near the edge of the glass substrate 2.

In other words, the cooling by the cooling plate 61 may be accomplished before the preheating unit 50 preheats the edge of the glass substrate 2 and/or while the preheating unit 50 preheats the edge of the glass substrate 2. Through the cooling by the cooling plate 61, the present invention allows the glass substrate 2 to be uniformly preheated, thereby guaranteeing continuous generation of chips 4.

As illustrated in FIG. 9, the cooling unit 60 may cool the edge of the substrate 2 by spraying a refrigerant e edge of the glass substrate 2 after the preheating unit 50 preheats the edge of the glass substrate 2. In this case, unlike the feature of cooling the glass substrate 2 before and during the preheating which is carried out by the cooling unit 60, the feature of cooling the glass substrate 2 after the preheating may be carried out by the temperature adjustment unit 42 of the housing 40, as explained above.

The cooling unit 60 (and/or temperature adjustment 42) may cool the glass substrate 2 by spraying a refrigerant gas having an extremely low temperature such as liquid nitrogen or liquid helium, etc. to the edge of the glass substrate 2 after the preheating unit 50 preheats the edge of the glass substrate 2. In this case, the cooling unit 60 may be configured to spray the same amount of refrigerant gas per unit time to the edge of the glass substrate 2 while moving along the edge of the glass substrate 2 at a constant velocity so that the inner side of the glass substrate 2 is uniformly cooled along the corner of the edge of the glass substrate 2.

Since the preheating unit 50 enables uniform heat conduction of the glass substrate 2 along the edge of the glass substrate 2, the cooling unit 60 which moves in the same pattern as the preheating unit 50 enables uniform heat conduction to the cooled portion applied to the glass substrate 2.

As such, after the heat delivery is guided by the cooling plate 61 so that the preheating of the preheating unit 50 is uniformly conducted within the glass substrate 2, the cooling unit 60 uniformly sprays the refrigerant gas to the edge of the glass substrate 2 having a uniform conductive heat, and accordingly, the edge of the glass substrate 2 may be uniformly cooled in a prescribed width.

Then, when the heating element 20 slides in contact with the glass substrate 2, even though the glass substrate 2 has an amorphous structure, the corner of the edge of the glass substrate 2 through which the heating element 20 passes could be continuously and naturally peeled.

In this case, when natural peeling is accomplished, the chip 4 may be peeled off from the corner of the edge of the glass substrate 2, and the portion from which the chip 4 is peeled off may be neatly chamfered.

Seen from a chamfering line 3, the chip 4 can have a uniform thickness only when the heat conduction is uniform along the corner of the edge of the glass substrate 2. The present invention may continuously peel off chips having a uniform thickness by limiting a preheating area through the guide of the cooling plate 61, forming a cooling line by the cooling in the preheating area, and forming a heating line by the heating element 20 in the cooling area, in order.

When heat change occurs repeatedly with respect to a virtual line along the corner of the edge of the glass substrate 2, the virtual line may become the chamfering line 3 for the chip 4 to be peeled off. It is important that only when the virtual line is formed in a straight line parallel to the corner of the edge of the glass substrate 2 the thickness of the chip 4 is uniform.

In order to form the virtual line which becomes the chamfering line 3 in a straight line, the present invention performs cooling and preheating as explained above, and allows uniform heat conduction in the glass substrate 2 before melting by the contact with the heating element 20, thereby guaranteeing continuous peeling of the chips 4 and high quality chamfering.

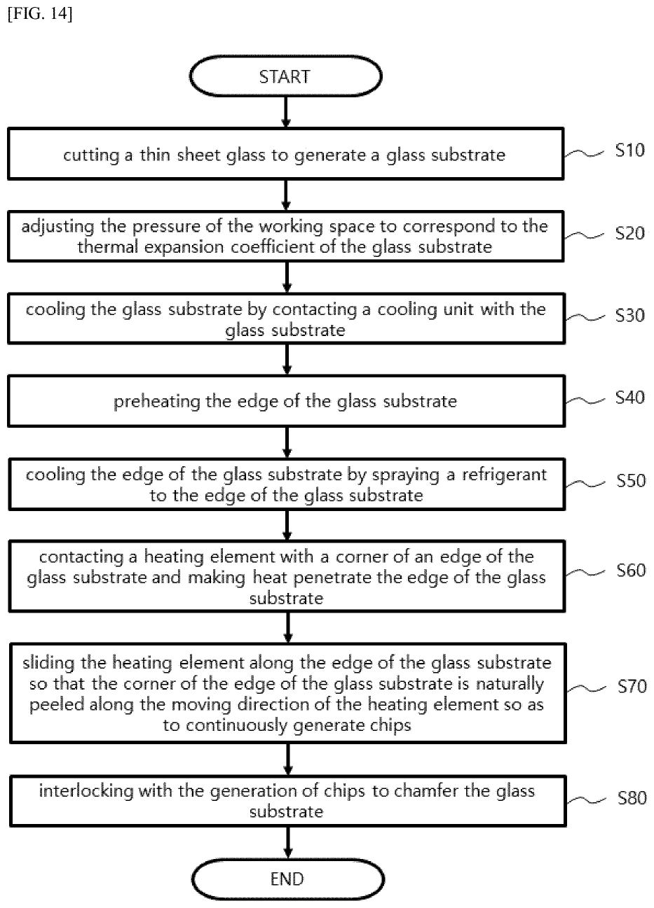

FIG. 14 is a flow chart illustrating the chamfering method according to one embodiment of the present invention.

When referring to FIG. 14, the chamfering method according to one embodiment of the present invention is a method for chamfering an edge of a glass substrate 2 by using the chamfering device 1 mentioned above, which comprises the following steps: cutting a thin sheet glass to generate a glass substrate 2 (S10), adjusting the pressure of the working space 45 to correspond to the thermal expansion coefficient of the glass substrate 2 (S20), cooling the glass substrate 2 by contacting the cooling unit 60 with the glass substrate 2 (S30), preheating the edge of the glass substrate 2 (S40), cooling the edge of the glass substrate 2 by spraying a refrigerant to the edge of the glass substrate 2 (S50), contacting a heating element 20 with a corner of the edge of the glass substrate 2 and making heat penetrate the edge of the glass substrate 2 (S60), sliding the heating element 20 along the edge of the glass substrate 2 so that the corner of the edge of the glass substrate 2 is naturally peeled along the moving direction of the heating element 20 so as to continuously generate chips 4 (S70), and interlocking with the generation of chips 4 to chamfer the glass substrate 2 (S80).

In step S10, a thin sheet glass is cut to generate the glass substrate 2. The thin sheet glass could be cut by a cutting unit, and the cutting could be implemented from the outside of the housing 40.

Various cutting means such as grinding, laser, etc. may be used, and the cut glass substrate 2 may have microscopic scratches at the edge thereof. As will be explained later, the present invention chamfers the edge of the glass substrate 2 in order to remove the microscopic scratches formed in the glass substrate 2.

Other than the cutting step, the following steps may be carried out within the working space 45 formed by the housing 40. Additionally, the environmental conditions (temperature, pressure, etc.) in which the following steps are performed may be effectively controlled by the housing 40 which forms a working space 45 isolated from the outside.

In step S20, the pressure of the working space 45 is adjusted to correspond to the thermal expansion coefficient of the glass substrate 2. The working space 45 may be formed by the housing 40, and the pressure inside the working space 45 may be adjusted. The pressure may be adjusted to correspond to the thermal expansion coefficient of the glass substrate 2, and a positive pressure or a negative pressure may be implemented according to the thermal expansion coefficient as explained above, and thus the detailed explanation thereon will be omitted.

Additionally, in this step, the temperature of the working space 45 may be adjusted. The temperature of the working space 45 may be implemented to be a temperature lower room temperature, and for example, the temperature of the working space 45 may be maintained to range between 0 and 10° C.

In step S30, the glass substrate 2 is cooled by contacting the cooling unit 60 with the glass substrate 2. In this step, the glass substrate 2 is cooled before preheating the edge of the glass substrate 2. The glass substrate 2 may be cooled to range between −10 and 0° C. by the cooling plate 61 which supports the top surface of the glass substrate 2.

As the glass substrate 2 is cooled in this step, a constant depth of heat conducted at the edge of the glass substrate 2 may be maintained along the longitudinal direction of the glass substrate 2 when the edge of the glass substrate 2 is heated in the following steps. Of course, this step may partially overlap with step S40 which will be mentioned later.

In step S40, as illustrated in FIG. 8, the edge of the glass substrate 2 is preheated. The preheating raises the temperature of the edge of the glass substrate 2 before being brought into contact with the heating element 20, and thus saves the enemy consumed by the heating element 20.

The preheating may be accomplished by the preheating unit 50 which delivers the same amount of heat per unit time while moving at a constant velocity along the edge of the glass substrate 2. Therefore, the edge of the glass substrate 2 is uniformly heated along the longitudinal direction.

In the preheating step, the cooling unit 60 (cooling plate 61) stays in contact with the glass substrate 2 to maintain a constant depth of the heat conducted at the edge of the glass substrate 2 by the preheating unit 50. Therefore, the present invention may have a uniform heat conduction at the edge of the glass substrate 2 which has an amorphous structure.

In step S50, as illustrated in FIG. 9, the edge of the glass substrate 2 is cooled by spraying a refrigerant to the edge of the glass substrate 2. The cooling by the spraying of a refrigerant may performed after the preheating, and may be implemented by a cooling unit 60 and/or a temperature adjustment unit 42.

In this step, like the preheating step, cooling is carried out by allowing the cooling unit 60 to move at a constant velocity along the edge of the glass substrate 2 and deliver the same cold heat per unit time, so that the edge of the glass substrate 2 is uniformly cooled along the longitudinal direction.

Accordingly, the edge of the glass substrate 2 is preheated and cooled along a virtual line parallel in the longitudinal direction, and the chamfering quality may be guaranteed when the virtual line forms the chamfering line 3.

In step S60, as illustrated in FIG. 10, the heating element 20 contacts a corner of the edge of the glass substrate 2 and makes heat penetrate the edge of the glass substrate 2. The heating element 20 may include platinum, and for example, may be an alloy of rhodium and platinum, as explained above.

When the heating element 20 contacts the corner of the edge of the glass substrate 2, the corner of the edge of the glass substrate 2 may melt by a high temperature of about 1,000° C. or above. In this case, even the virtual line melts.

In step S70, as illustrated in FIG. 13, the heating element 20 slides along the edge of the glass substrate 2 so that the corner of the edge of the glass substrate 2 is naturally peeled along the moving direction of the heating element 20 so as to continuously generate chips 4.

Like the preheating unit 50 and the cooling unit 60, the heating element 20 also slides at a constant velocity along the edge of the glass substrate 2, thereby emitting the same heat per unit time. The corner of the edge of the glass substrate 2 that the heating element 20 contacts may melt up to a virtual line parallel in the longitudinal direction of the glass substrate 2. In this case, when the heating element 20 slides, the portion melted to the virtual line is peeled off, thereby generating the chip 4.

Therefore, the present invention performs the cooling, preheating, etc. before the heating element 20 is brought into contact so that a uniform heat conduction is implemented to the virtual line parallel in the longitudinal direction with respect to the edge of the glass substrate 2. Additionally, the present invention melts the edge of the glass substrate to the virtual line with the heating element 20, so that the chip 4 could be peeled off allowing the virtual line to correspond to the chamfering line 3.

In this case, since a uniform heat conduction is implemented to the virtual line, the present invention may guarantee continuously generating chips 4 during the process of peeling off chips 4 while sliding the heating element 20, and allow the chamfered portion not to be disconnected.

In step S80, as illustrated in FIG. 1I, the glass substrate 2 is chamfered by interlocking with the generation of chips 4. When the chip 4 is naturally peeled like apples, the portion from which the chip 4 is peeled is chamfered allowing the virtual line to be the chamfering line 3. Therefore, unlike the polishing operation, etc. which has unnecessary residues left, a neat chamfering of high quality may be implemented on the edge of the glass substrate 2.

As such, the present embodiment allows the heating element 2 to include platinum, etc., and thus even if the glass substrate 2 melts, the adhesion to the heating element 20 could be minimized. Additionally, by performing the process of cooling, preheating, etc. before the melting, uniform heat conduction can be implemented with respect to the glass substrate 2 and the chips 4 can be continuously generated with a constant thickness, thereby greatly improving the chamfering quality.

The present invention was explained in detail through specific embodiments. However, said embodiments are for specifically explaining the present invention, and the present invention is not limited thereto. Additionally, it is obvious that a person having ordinary skill in the art may make modifications or improvements thereto within the technical idea of the present invention.

Simple modification or change to the present invention falls within the scope of the present invention, and the detailed protection scope of the present invention will be clarified by the claims attached herewith.

### EXPLANATION ON REFERENCE NUMERALS

| | |
|---|---|
| 1: chamfering device | 2: glass substrate |
| 3: chamfering line | 4: chip |
| 10: frame | 11: shelf |
| 12: support | 13: caster |
| 20: heating element | 21: coil |
| 22: power unit | 30: moving unit |
| 31: rail | 32: motor |
| 40: housing | 41: opening/closing unit |
| 42: temperature adjustment unit | 421: chiller |
| 43: pressure adjustment unit | 431: gas injection unit |
| 432: discharge duct | 433: damper |
| 434: negative pressure forming unit | 44: sensor |
| 45: working space | 50: preheating unit |
| 60: cooling unit | 61: cooling plate |

What is claimed is:

1. A chamfering device for chamfering an edge of a glass substrate, comprising:
a heating element which contacts a corner of the edge of the glass substrate and makes heat penetrate the edge of the glass substrate; and
a moving unit for sliding the heating element along the edge of the glass substrate, wherein the moving unit slides the heating element so that the corner of the edge of the glass substrate is naturally peeled along the moving direction of the heating element so as to continuously generate chips to chamfer the glass substrate.

2. The chamfering device of claim 1, wherein the heating element comprises at least platinum.

3. The chamfering device of claim 2, wherein the heating element is a mixture of at least rhodium and platinum.

4. The chamfering device of claim 3, wherein the heating element is a mixture of rhodium and platinum so that the ratio of platinum is relatively higher than rhodium.

5. The chamfering device of claim 1, further comprising:
a housing formed with a working space which accommodates the glass substrate therein, chamfers the edge of the glass substrate, and is isolated from the outside.

6. The chamfering device of claim 5, wherein the housing comprises a temperature adjustment unit which adjusts the temperature of the working space or a pressure adjustment unit which adjusts the pressure of the working space.

7. The chamfering device of claim 6, wherein the housing maintains a constant temperature or pressure of the working space.

8. The chamfering device of claim 6, wherein the pressure adjustment unit adjusts the pressure of the working space to correspond to the thermal expansion coefficient of the glass substrate.

9. The chamfering device of claim 8, wherein the pressure adjustment adjusts the pressure of the working space to a pressure higher than a reference pressure when the thermal expansion coefficient of the glass substrate is high, and adjusts the pressure of the working space to a pressure lower than the reference pressure when the thermal expansion coefficient of the glass substrate is low.

10. The chamfering device of claim 6, wherein the housing further comprises a sensor which senses at least one of the temperature and the pressure of the working space.

11. The chamfering device of claim 6, wherein the pressure adjustment unit adjusts the pressure of the working space by injecting inert gas into the working space, or discharging gas inside the working space to the outside.

12. The chamfering device of claim 6, further comprising a preheating unit which preheats the edge of the glass substrate before being brought into contact with the heating element.

13. The chamfering device of claim 12, wherein the preheating unit preheats the edge of the glass substrate to a temperature above the temperature inside the working space and below the heating temperature of the heating element.

14. The chamfering device of claim 12, further comprising a cooling unit which cools the glass substrate before or after preheating the edge of the glass substrate.

15. The chamfering device of claim 14, wherein the cooling unit cools the glass substrate by contacting the glass substrate, lowering the temperature inside the working space, or spraying a refrigerant to the glass substrate.

16. The chamfering device of claim 14, wherein the temperature adjustment unit maintains the temperature inside the working space to range between 0 and 10° C., and the cooling unit cools the glass substrate to range between −10 and 0° C.

17. The chamfering device of claim 15, wherein the cooling unit cools the glass substrate by contacting the glass substrate before the preheating unit preheats the edge of the glass substrate, and cools the edge of the glass substrate by spraying a refrigerant to the edge of the glass substrate after preheating the edge of the glass substrate.

18. A chamfering method for chamfering an edge of a glass substrate, comprising:
contacting a heating element with a corner of the edge of the glass substrate and making heat penetrate the edge of the glass substrate;
sliding the heating element along the edge of the glass substrate so that the corner of the edge of the glass substrate is naturally peeled along the moving direction of the heating element so as to continuously generate chips; and
interlocking with the generation of chips to chamfer the glass substrate.

19. The chamfering method of claim 18, wherein the heating element comprises at least platinum.

20. The chamfering method of claim 19, wherein the heating element is a mixture of at least rhodium and platinum.

21. The chamfering method of claim 18, wherein the steps of making heat pentrate the edge of the glass substrate, forming the chip, and chamfering the glass substrate are carried out n a working space which accommodates the glass substrate therein, chamfers the edge of the glass substrate, and is isolated from the outside.

22. The chamfering method of claim 21, further comprising:
adjusting the pressure of the working space to correspond to the thermal expansion coefficient of the glass substrate.

23. The chamfering method of claim 22, wherein the step of adjusting the pressure of the working space adjusts the pressure of the working space to a pressure higher than a reference pressure when the thermal expansion coefficient of the glass substrate is high, and adjusts the pressure of the working space to a pressure lower than the reference pressure when the thermal expansion coefficient of the glass substrate is low.

24. The chamfering method of claim 18, further comprising:
preheating the edge of the glass substrate before being brought into contact with the heating element.

25. The chamfering method of claim 24, further comprising:
cooling the glass substrate by contacting the cooling unit with the glass substrate before preheating the edge of the glass substrate.

26. The chamfering method of claim 25, wherein in the step of preheating the edge of the glass substrate, the cooling unit stays in contact with the glass substrate to maintain a constant depth of the heat conducted at the edge of the glass substrate by the preheating unit.

27. The chamfering method of claim 26, further comprising:
cooling the edge of the glass substrate by spraying a refrigerant to the edge of the glass substrate after preheating the edge of the glass substrate.

28. The chamfering method of claim 18, further comprising:
cutting a thin sheet glass to generate the glass substrate.
